(19) United States
(12) Patent Application Publication
(10) Pub. No.: US 2005/0252747 A1
(43) Pub. Date: Nov. 17, 2005

(54) Clutch release mechanism

(75) Inventors: David Godlew, Franklin, MI (US); Greg Papp, Brownstown, MI (US)

Correspondence Address: John R. Buser;Brooks Kushman P.C., 1000 Town Center, 22nd Floor, Southfield, MI, 48075-1238, US

(73) Assignee: Eaton Corporation, Cleveland, OH (US)

(21) Appl. No.: 10/843,071

(22) Filed: May 11, 2004

(51) Int. Cl. F16D 13/50; F16D 23/14; F16D 25/08

(52) U.S. Cl. 192/91 A; 192/85 CA; 192/98

(57) ABSTRACT

A clutch release mechanism. The clutch release mechanism for use with a clutch of the type which connects an engine output member to a transmission input member. The clutch release mechanism including a piston and a cylinder. The piston is moveable within the cylinder to engage/disengage the clutch.

### BACKGROUND OF THE INVENTION

1. Field of the Invention

The present invention relates to a clutch release mechanism. The clutch release mechanism connects an engine output member to a transmission input member.

2. Background Art

A clutch connects an engine output member to a transmission input member. Friction clutches establish a frictional connection between the engine output member and the transmission input member.

Application serial No. 2002/0139633 relates to a release assembly for a friction clutch that utilizes a diaphragm spring in combination with a pressure plate to establish a friction connection between the transmission input member and the engine output member. The release assembly controls the application of the clutch.

The release assembly includes a yoke that moves a cylinder against the diaphragm spring. The yoke positions the cylinder to either flex the diaphragm spring or release the flex on the diaphragm spring. The yoke is connected to a pivot and a linkage. The linkage is required to move the yoke about the pivot to translate the cylinder.

When flexed, the diaphragm spring does not apply pressure to the pressure plate. Without pressure on the pressure plate, there is no friction connection between the transmission input member and the engine output member. When unflexed, the diaphragm spring applies pressure to the pressure plate and the transmission input member is frictionally connected to the engine output member.

The inventors of the present invention have identified a need to eliminate the yoke and its corresponding linkage and pivot to reduce and save space.

### SUMMARY OF THE INVENTION

According to one aspect of the present invention, a clutch release mechanism is provided that eliminates the yoke, linkage and pivot of the prior art. The improved release mechanism of the present invention saves space and is operable with a variety of clutches within standard clutch housings.

According to another aspect of the present invention, a release mechanism is provided that includes a cylinder and a piston. The piston is operably supported within the cylinder cavity that is defined by the position of the piston within the cylinder. The cylinder cavity can be expanded and contracted by pressurization. The cylinder includes an opening through which a fluid can flow to pressurize the cavity. The fluid pressure is controlled to move the piston within the cylinder.

According to another aspect of the present invention, the release mechanism is configured to operate with a friction clutch having a diaphragm spring. The piston is moved according to the cylinder pressure to flex and release the diaphragm spring. The piston flexes the diaphragm spring when actuated and the piston releases the diaphragm spring when not actuated. The released spring applies force to the pressure plate to permit the frictional connection between the engine output member and the transmission input member. The flexed diaphragm spring pivots away from the pressure plate so that little if any force is applied to the pressure plate. Without force being applied to the pressure plate the frictional connection is lost and the engine output member is disconnected from the transmission input member.

Another aspect of the invention relates to the diaphragm spring being flexed and released by the cylinder. The cylinder cavity expands with pressurization to move the piston against fingers of the diaphragm spring. The fingers move laterally with the piston to flex the diaphragm spring. The diaphragm spring is released by reducing pressure in the cylinder cavity. The released spring applies pressure to the pressure plate to establish the frictional connection between the engine output member and the transmission input member.

In an alternative embodiment of the present invention, the piston can include a linkage. The linkage may be connected to the fingers of the diaphragm spring. The linkage is permanently connected to the fingers so that they must move with any movement of the piston. The linkage can be effective to shorten the time required to the flex and release the diaphragm spring.

According to a further aspect of the present invention, the release mechanism can also function as a transmission shaft bearing support. An outer portion of the cylinder can be configured to form an outer wall that supports a transmission shaft bearing assembly. The support provided by the cylinder eliminates the need to provide a separate structure for supporting the transmission shaft bearing assembly. The release mechanisms can be incorporated in a SAE #1 clutch housing.

### BRIEF DESCRIPTION OF THE DRAWINGS

FIG. 1 is a schematic representation of a vehicle drive drivetrain system having a clutch that may include a clutch release mechanism made in accordance with the present invention;

FIG. 2 is a cross-section view of a clutch made according to one embodiment of the present invention in an engaged position;

FIG. 3 is a cross-sectional view of the clutch shown in FIG. 2 in a disengaged position;

FIG. 4 is a fragmentary detailed sectional view of a clutch release mechanism made in accordance with one embodiment of the present invention; and

FIG. 5 is an exploded perspective view of the clutch and clutch release mechanism.

### DETAILED DESCRIPTION OF THE PREFERRED EMBODIMENT(S)

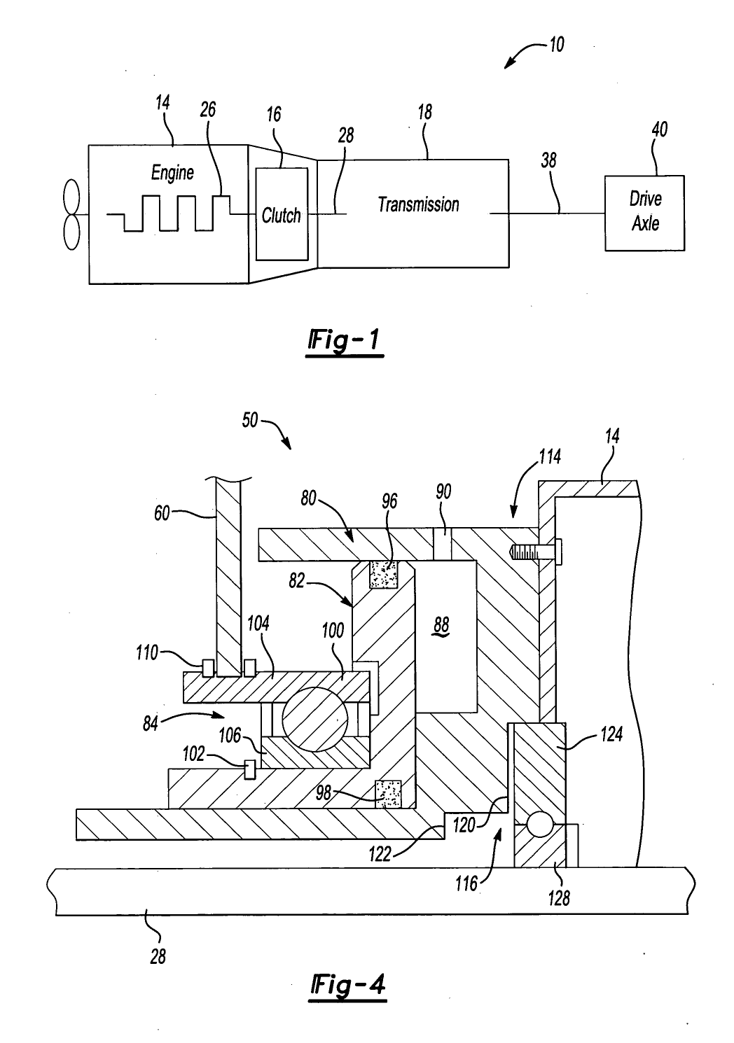

Referring to FIG. 1, a vehicle drivetrain system 10 is illustrated that has an engine 14, a clutch 16, and a transmission 18. The clutch 16 connects an engine output member 26 to a transmission input member 28. The engine output member 26 can be an engine crankshaft. The transmission input member 28 can be a transmission input shaft.

The 16 clutch can be a friction clutch that establishes a frictional connection between the engine output member 26 and the transmission input member 28. The frictional connection causes the transmission shaft 28 to rotate with the engine crankshaft 26. The rotating transmission shaft 28 cooperates with gearing in the transmission 18 to turn a transmission output shaft 38 that rotates drive axle 40.

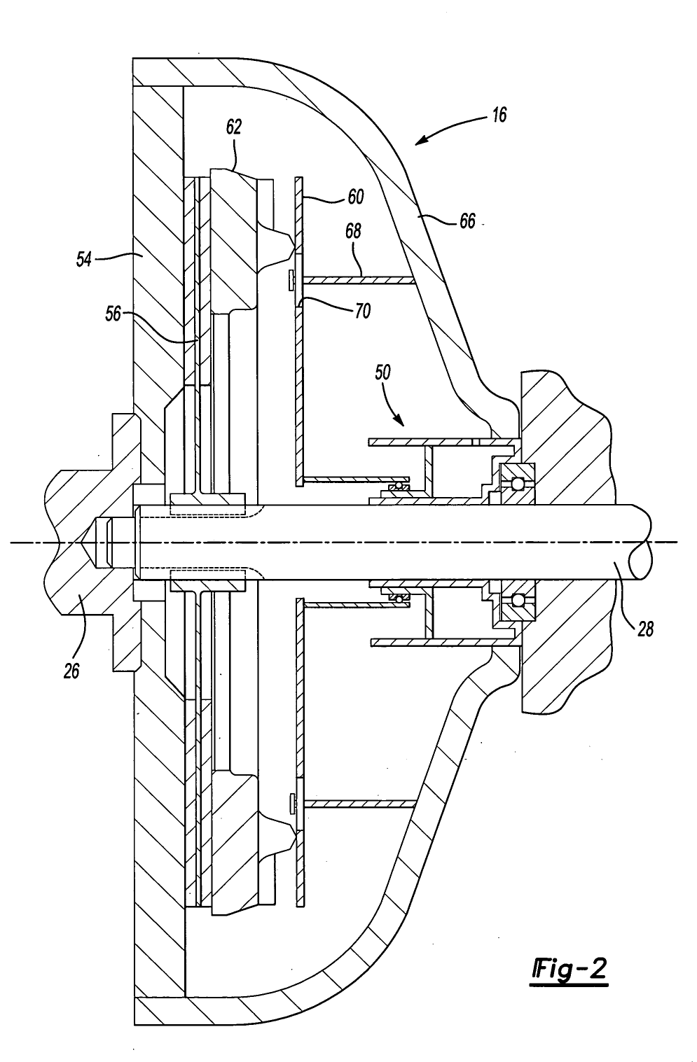

Referring to FIG. 2, the clutch 16 is shown that includes a release mechanism 50 made in accordance with the present invention. The clutch 16 includes a flywheel 54 and a clutch plate 56. The flywheel 54 is affixed to the engine crankshaft 26. The clutch plate 56 is affixed to the transmission shaft 28. A diaphragm spring 60 is pivotally connected to the clutch release mechanism 50 and selectively applies force to a pressure plate 62. The force applied to the pressure plate 62 generates a frictional connection between the flywheel 54 and the clutch plate 56 to transmit torque from the crankshaft 26 to the transmission input shaft 28.

The clutch 16 includes a housing 66. The housing 66, for example, may be a SAE #1 clutch housing. The housing 66 extends from the engine 14 to the transmission 18. A pivot pin 68 attaches to the housing 66 to support the diaphragm spring 60. The diaphragm spring 60 includes an opening 70 so that the spring 60 can translate along the pivot pin 68. The diaphragm spring 60 can be flexed and released about the pivot pin 68 to control the application of pressure by the diaphragm spring 60 to the pressure plate 62.

The vehicle clutch 16 shown in FIG. 2 is provided as an example, and is not intended to limit the scope of the present invention. The release mechanism 50 is operable with a wide variety of other clutch arrangements, regardless of whether the clutch 16 includes the illustrated or other components.

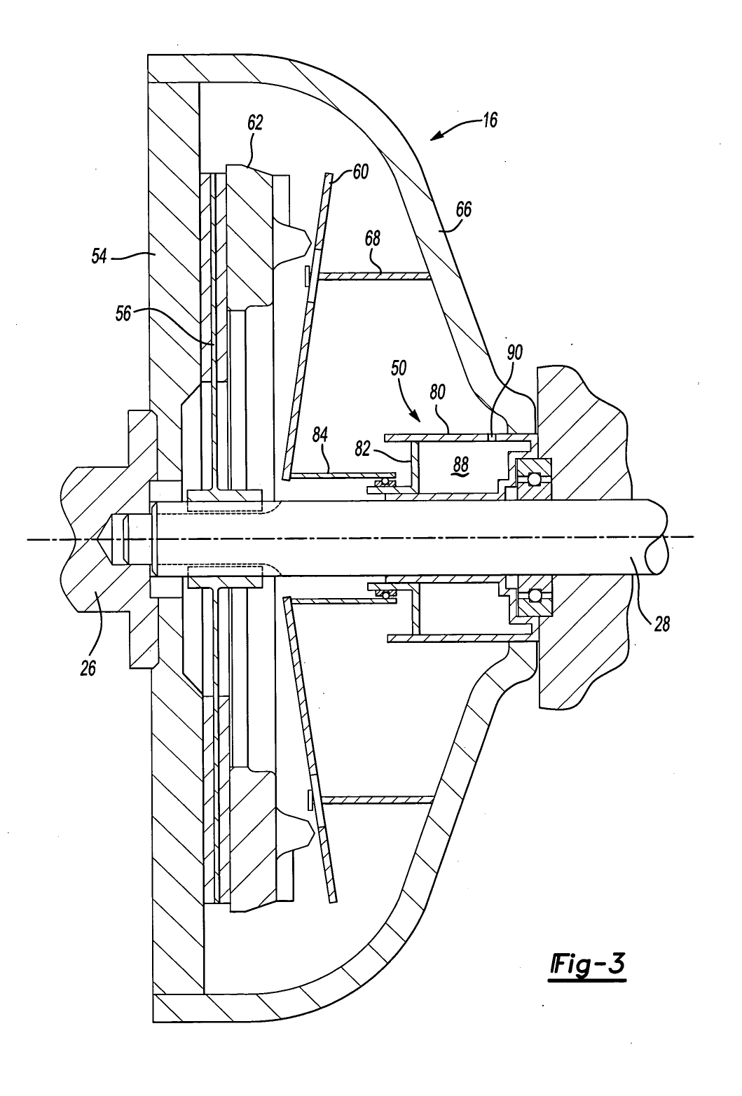

In FIG. 2, the engine output member 26 is connected to the transmission input member 28 and is described as being engaged in this state. FIG. 3 illustrates the engine output member 26 disconnected from the transmission member 28 and is described as being disengaged in this state. Engagement and disengagement refer to whether a frictional connection is established between the flywheel 54 and the clutch plate 56.

The diaphragm spring 60 controls whether the clutch 16 is engaged or disengaged. The diaphragm spring 60, as shown in FIG. 2, is released so that it applies force to the pressure plate 62. Pressure plate 62 in turn applies force to the clutch plate 56 so that the frictional connection is established between the flywheel 54 and the clutch plate 56. Diaphragm spring 60, as shown in FIG. 3, is flexed so that it does not apply force to the pressure plate 62. The pressure plate 62 in turn does not apply force to the clutch plate 56 and there is no frictional connection between the flywheel 54 and clutch plate 56.

Flexing and releasing of the diaphragm spring 60 is controlled by the clutch release mechanism 50. The release mechanism 50 as illustrated includes a cylinder 80, a piston 82, and a linkage 84. Linkage 84 engages the diaphragm spring 60 to apply force to a central portion of the diaphragm spring 60. A plurality of fingers 86 can be provided in the central portion of the diaphragm spring 60. Linkage 84 flexes the diaphragm spring 60 by moving laterally against the spring 60. Linkage 84 is moved into and out of engagement with the diaphragm spring 60 depending whether pressure is supplied to a cylinder cavity 88.

Cylinder cavity 88 is defined by the position of the piston 88 within the cylinder 80. An opening 90 is provided in the cylinder 80 that is adapted to receive a valve (not shown) or other connector through which fluid is delivered to and released from the cylinder cavity 88. A pump or other source of pressurized fluid (not shown) is in fluid flow communication with the opening 90. A vehicle control module or similar control mechanism can regulate the selective supply of pressurized fluid in and out of the cavity 88.

When fluid under pressure is suppled to the cavity 88, the piston 82 flexes the diaphragm spring 60. The flexed diaphragm spring 60 can be rapidly released by releasing the fluid from the cylinder. The biasing force of the spring 60 forces the piston 82 laterally back into the cylinder cavity 88 when the pressure is released. The spring 60 may then be flexed again by pressurizing the cavity 88. The process is selectively repeated to control engagement/disengagement of the clutch 16.

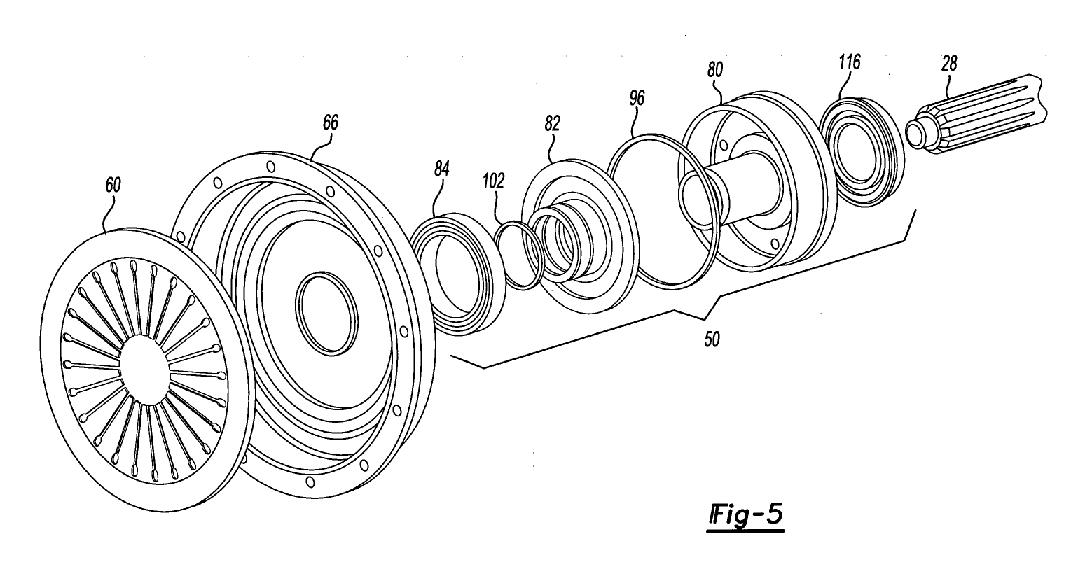

Referring to FIG. 4, a detailed cross-sectional view of the release mechanism 50 is provided to show additional details of the release mechanism 50. The release mechanism 50 includes seals 96 and 98 between the piston 82 and the cylinder 80 that seal off the cavity 88. Seals 96 and 98 help maintain the pressure in the cylinder cavity 88.

The linkage 84 includes a bearing 100 that is secured to piston by a snap ring 102. A first side 104 of the bearing 100 contacts the diaphragm spring 60 and a second side 106 of the bearing 100 is secured by the snap ring 102. The first side 104 in the illustrated embodiment includes a race 110. The race 110 permanently connects the diaphragm spring 60 to the linkage 84. The race 110 can be eliminated, as shown in FIGS. 2-3, and if so an end of the linkage 84 may contact the diaphragm spring 60.

Gaps between the diaphragm spring 60 and the linkage 84 are eliminated by permanently connecting the race 110 to the diaphragm spring 60 and the linkage 84. In the absence of race 110, gaps can be created between the linkage 84 and the diaphragm 60 if the piston 82 and linkage 84 move too far back into the cylinder cavity 88 during release of the diaphragm spring 60. The biasing force of diaphragm spring 60 urges the piston 82 and linkage 84 back into the cavity 88 when the cavity pressure is released. The gap must first be closed to flex the diaphragm spring 60. The race 110 fixes the linkage 84 to the spring 60 to eliminate the gaps and shorten the response time of the release mechanisms 50.

Cylinder 80 includes an outer wall 114 that mates with the transmission 14. Outer wall 114 is configured to support a transmission shaft bearing assembly 116. The outer wall 114 includes a first recess 120 and a second recess 122. The first recess 120 supports an outer ring 124 of the transmission shaft bearing assembly 116. The second recess 122 provides a clearance for an inner ring 128 of the transmission shaft bearing 116.

An advantage of this arrangement is that the release mechanism 50 supports the transmission shaft bearing assembly 116. The integrated support eliminates the need for an additional support component to be mounted to the release mechanism 50. The overall length of the clutch 16 is reduced by eliminating the stack-up necessitated by the additional support component. This allows the release mechanism 50 to be used with a number of different clutches and clutch configurations. The length of the cylinder 80 along the shaft 28 can be less than three inches so that the release mechanism 50 is operable with a SAE #1 clutch housing.

Referring to FIG. 5, an exploded perspective view illustrates the component parts of the release mechanism 50. The transmission shaft 28 receives the release mechanism 50. The release mechanism 50 comprises the transmission support bearing 116, the cylinder 80, the cylinder seal 96, the piston 82, the piston snap ring 102, and the linkage 84. The clutch housing 66 and the diaphragm spring 60 are also assembled to the shaft 28 as shown. The present invention should not be limited to the this exemplary assembly configuration. Rather, the illustrated embodiments are merely examples of assemblies that are operable with the release mechanism 50 of the present invention. The diaphragm spring 60 may be elimintaed or other commonly used components of the assembly of FIG. 5 may be eliminated to provide a different clutch configuration that may be operable with the clutch release mechanism of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A clutch release mechanism for a clutch that is assembled to a shaft with the clutch release mechanism, the clutch release mechanism comprising:
a cylinder disposed on the shaft;
a piston movably supported within the cylinder between an engaged position in which the clutch is engaged and a released position in which the clutch is disengaged; and
a source of fluid in fluid communication with the cylinder that selectively provides fluid under pressure to the cylinder to move the piston to the engaged position and from which fluid is parted to move the piston to the released position.

2. The mechanism of claim 1 wherein the clutch includes a diaphragm spring, and the release mechanism further includes a linkage fixed to the piston that is operable in conjunction with movement of the piston to flex the diaphragm spring.

3. The mechanism of claim 2 wherein the linkage includes a race that permanently connects the linkage to the diaphragm spring.

4. The mechanism of claim 1 wherein the cylinder and piston define a cavity in fluid communication with the source of fluid under pressure wherein the piston is moved within the cavity.

5. The mechanism of claim 1 wherein the cylinder includes an outer wall having a portion adapted to support a transmission shaft bearing associated with a transmission.

6. The mechanism of claim 1 wherein the cylinder is less than three inches in length as measured along the shaft.

7. A clutch comprising:
a shaft;
a cylinder assembled to the shaft;
a piston movably supported within the cylinder on the shaft that defines a cavity, the size of the cavity being defined by the position of the piston in the cylinder;
a friction coupling mechanism assembled to the shaft that is shifted between an engaged position and a disengaged position as the piston moves within the cavity; and
a source of fluid in communication with the cylinder cavity, the source of fluid being relatively parted to the cylinder cavity to control movement of the piston within the cavity.

8. The system of claim 7 wherein the clutch is disengaged if the piston is in a first position and the clutch is engaged if the piston is in a second position.

9. The system of claim 8 wherein the fluid is provided by a source of fluid to the cylinder cavity in a single time interval.

10. The system of claim 9 wherein the fluid is returned to the source of pressurized fluid from the cylinder cavity.

11. The system of claim 7 wherein the friction coupling includes at least one clutch plate and a diaphragm spring that is selectively flexed to engage and disengage the clutch, the piston being operable to flex and release the diaphragm spring relative to the at least on clutch plate to control engagement and disengagement of the clutch.

12. The system of claim 11 further comprising a linkage connected to the piston and the diaphragm spring.

13. The system of claim 12 further comprising a snap ring that secures the linkage to the piston.

14. The system of claim 12 further comprising a race that connects the linkage to the diaphragm spring.

15. The system of claim 7 wherein the cylinder includes an outer wall having a portion adapted to support a transmission shaft bearing associated with a transmission.

16. The mechanism of claim 1 wherein the housing is a SAE #1 clutch housing, wherein a thickness of the cylinder along the shaft is less than 3 inches so that the release mechanism is operable with the SAE #1 clutch housing.

17. A method of operating a clutch to connect a engine output member with a transmission input member, the method comprising:
providing a clutch having a piston and a cylinder defining a cylinder cavity, the piston being moveable within the cavity;
supplying fluid under pressure to the cylinder cavity to move the piston to a first position in the cylinder;
withdrawing fluid from the cylinder cavity to move the piston to a second position;
flexing a diaphragm spring when the piston is in the first position for connecting the engine output member to the transmission input member; and
releasing the diaphragm spring when the piston is in the second position for disconnecting the engine output member from the transmission input member.

18. The method of claim 17 wherein the step of supplying fluid into the cylinder cavity is performed in a single boost to maximize the fluid pressure within the cylinder to facilitate movement of the piston and disconnecting the engine output member and the input member.

19. The system of claim 18 wherein releasing fluid from the cylinder comprises relieving pressure within the cylinder cavity to connect the engine output member to the input member.

20. The method of claim 17 further comprising providing a race that is secured to the diaphragm spring and operable with the piston, wherein the piston response time is shortened because the piston moves with the diaphragm spring.
